(19) United States
(12) Patent Application Publication
(10) Pub. No.: US 2011/0260500 A1
(43) Pub. Date: Oct. 27, 2011

(54) ROOF ASSEMBLY FOR STORAGE CONTAINER

(76) Inventors: Brett Allen Brooks, Lexington, SC (US); Patrick M. Griffin, Lafayette, IN (US); David Pickup, Lafayette, IN (US); Rodney P. Ehrlich, Monticello, IN (US); Andrzej Wylezinski, Lafayette, IN (US); Michael L. Thoma, Lafayette, IN (US); Dwaine D. Speer, West Lafayette, IN (US)

(21) Appl. No.: 13/088,596

(22) Filed: Apr. 18, 2011

Related U.S. Application Data
(60) Provisional application No. 61/326,949, filed on Apr. 22, 2010.

(51) Int. Cl. B62D 25/06

(52) U.S. Cl. 296/185.1; 296/210

(57) ABSTRACT

A roof assembly for a storage container, such as a truck trailer, includes a sheet having a plurality of laterally-extending corrugations formed therein. Illustratively, each corrugation is configured to progressively flatten outwardly from a longitudinal centerline of the roof assembly towards an outer end of the sheet. The longitudinal centerline of the roof assembly extends perpendicular to each corrugation. The outer end of the sheet is configured to be coupled to a sidewall of the truck trailer.

This application claims priority under 35 U.S.C. §119(e) to U.S. Provisional Patent Application Ser. No. 61/326,949 entitled ROOF ASSEMBLY FOR STORAGE CONTAINER and filed Apr. 22, 2010, the entirety of which is hereby incorporated by reference herein.

Cross-reference is made to U.S. Utility application Ser. No. 12/721,027 entitled PANEL FOR A STORAGE CONTAINER which was filed on Mar. 10, 2010 by Joseph M. Zachman, et al. Cross-reference is also made to U.S. Utility application Ser. No. 11/563,796 (now abandoned) entitled ROOF STRUCTURE FOR A TRAILER which was filed on Nov. 29, 2006 by Rodney P. Ehrlich. The entirety of each of these applications is hereby expressly incorporated by reference herein.

### FIELD OF THE INVENTION

The present invention relates generally to a roof assembly for a storage container, such as a truck trailer, for example. In particular, the present invention relates to a roof assembly having an external support structure.

### BACKGROUND

Many storage containers, such as large truck trailers, for example, include a roof assembly. Oftentimes, such roof assemblies include an exterior roof panel or panels and a plurality of roof bows coupled to an interior surface of the roof panel(s). Such roof bows, therefore, depend downwardly from the interior surface of the roof panel(s) into an interior storage area of the trailer. Thus, the roof bows may be damaged from fork truck masts and/or cargo as cargo is loaded and unloaded from the storage area of the trailer.

### SUMMARY

The present invention may comprise one or more of the features recited in the attached claims, and/or one or more of the following features and combinations thereof.

According to one aspect of the present disclosure, a roof assembly for a storage container, such as a truck trailer, includes a sheet having a plurality of laterally-extending corrugations formed therein. Illustratively, each corrugation is configured to progressively flatten outwardly from a longitudinal centerline of the roof assembly towards an outer end of the sheet. The longitudinal centerline of the roof assembly is perpendicular to each corrugation. The outer end of the sheet is configured to be coupled to a sidewall of the truck trailer.

In one illustrative embodiment, each outer end of the sheet may provide a continuous, generally planar surface of the roof assembly that is configured to be coupled to the sidewall of the truck trailer.

In another illustrative embodiment, a cross-section of each corrugation taken at the centerline of the roof assembly may be generally semi-circular in shape.

In still another illustrative embodiment, a height of each corrugation taken at the centerline of the roof assembly may be approximately 1.0 inch. Further, a height of the outer end of the sheet may be approximately 0.24 inch.

In yet another illustrative embodiment, a distance between the center of two adjacent corrugations taken at the centerline of the roof assembly may be approximately 1.5 inches.

In another illustrative embodiment, the sheet may be made from a composite material. The composite material may include a foam core, an outer skin coupled to the foam core, and an inner skin coupled to the foam core.

In still another illustrative embodiment, the sheet may be bowed upwardly across a width of the roof assembly.

In yet another illustrative embodiment, the roof assembly may also include a second sheet having a plurality of laterally-extending corrugations formed therein. Each corrugation of the second sheet may be configured to progressively flatten outwardly from a longitudinal centerline of the roof assembly that is perpendicular to each corrugation towards an outer end of the sheet that is configured to be coupled to the sidewall of the truck trailer.

In still another illustrative embodiment, the interior surface of the sheet is generally devoid of support structures depending downwardly therefrom.

According to another aspect of the present disclosure, a roof assembly for a storage container, such as a truck trailer, includes a plurality of exterior support structures configured to be coupled to a sidewall of the truck trailer. Each exterior support structure is configured to extend across a width of the truck trailer. Further, a height of each exterior support structure defines a first height at a longitudinal centerline of the roof assembly that is different than a second height at a peripheral end of the roof assembly.

In one illustrative embodiment, the roof assembly may further include a lower sheet having a generally planar interior surface configured to face toward an interior storage space of the truck trailer. Further, the plurality of exterior support structures may each be coupled to an exterior surface of the lower sheet. Further illustratively, the plurality of exterior support structures may include a plurality of roof bows. Each roof bow may include (i) a top wall spaced-apart from and generally parallel to the exterior surface of the lower sheet, (ii) a pair of side walls coupled to the top wall and extending between the top wall and the exterior surface of the lower sheet, and (iii) a flange coupled to each side wall and to the exterior surface of the lower sheet.

In another illustrative embodiment, the plurality of exterior support structures may include corrugations formed in a sheet. Further, the sheet may also include a planar section between adjacent corrugations. Illustratively, a cross-section of each corrugation taken at a longitudinal centerline of the roof assembly may be generally semi-circular in shape. Illustratively, the sheet may be made from a composite material that may include a plastic core, an inner metal skin coupled to an inner surface of the plastic core, and an outer metal skin coupled to an outer surface of the plastic core. Further illustratively, substantially an entire outer surface of the outer metal skin may be configured to be exposed to the surrounding environment and substantially an entire inner surface of the inner metal skin may be configured to be exposed to an interior storage space of the truck trailer.

In another illustrative embodiment, first height may be greater than the second height.

According to another aspect of the present disclosure, a storage container such as a trailer, for example, includes first and second sidewall assemblies spaced-apart from each other, a front end wall assembly coupled to each of the first and second sidewall assemblies, and a rear end wall assembly coupled to each of the first and second sidewall assemblies. The storage container also includes a roof assembly coupled to the first and second sidewall assemblies, the front end wall assembly, and the rear end wall assembly in order to define a storage space therein. Illustratively, the roof assembly includes a composite panel having a plurality of corrugations formed therein. Each corrugation of the plurality of corrugations extends across a width of the storage container from the first sidewall to the second sidewall. Illustratively, the composite panel includes a plastic core, an inner metal skin coupled to an inner surface of the plastic core, and an outer metal skin coupled to an outer surface of the plastic core. Further, substantially an entire outer surface of the outer metal skin is exposed to the surrounding environment, and substantially an entire inner surface of the inner metal skin is exposed to the storage space.

In one illustrative embodiment, each corrugation defines a first height at a longitudinal centerline of the roof assembly that is greater than a second height at a peripheral end of the roof assembly.

According to still another aspect of the present disclosure, a roof assembly for a storage container, such as a truck trailer, includes a lower sheet having an exterior surface and an interior surface configured to face toward an interior space of the storage container. The roof assembly further includes a plurality of roof bows coupled to the exterior surface of the lower sheet. Illustratively, each roof bow is configured to extend across a width of the storage container, and each roof bow defines a first height and/or a first width at a longitudinal centerline of the roof assembly that is different than a respective second height and/or a respective second width at a peripheral end of the roof assembly.

In one illustrative embodiment, the first height may be greater than the second height. Further illustratively, the first width may be the same as the second width. Alternatively, the first width may be less than the second width.

In another illustrative embodiment, each roof bow may include a top wall spaced-apart from and generally parallel to the exterior surface of the lower sheet, a pair of side walls coupled to the top wall and extending between the top wall and the exterior surface of the lower sheet, and a flange coupled to each side wall and to the exterior surface of the lower sheet. Illustratively, substantially the entire top surface of the top wall of each of the plurality of roof bows may be open to the surrounding environment. Further illustratively, the roof assembly may include a plurality of cavities defined between the exterior surface of the lower sheet and the top and side walls of each roof bow. The roof assembly may include a foam material positioned between the exterior surface of the lower sheet and the top wall of at least one of the plurality of roof bows. Further illustratively, the side walls may be configured to angle outwardly away from the top wall toward the exterior surface of the lower sheet. The flanges of adjacent roof bows may be spaced-apart from each other. An illustrative distance between the flanges of any two adjacent roof bows may generally be the same. Alternatively, a first distance between the flanges of any two adjacent roof bows may be different from a second distance between the flanges of any other two adjacent roof bows. Further alternatively, the flanges of adjacent roof bows may be engaged with each other.

In yet another illustrative embodiment, each roof bow may be coupled to the exterior surface of the lower sheet by an adhesive, a weld, and/or a mechanical fastener.

In still another illustrative embodiment, the lower sheet may be made of a composite material. Illustratively, the composite material may include a plastic core and inner and outer metal skins.

In yet another illustrative embodiment, the lower sheet and the plurality of roof bows may define a first panel, and the roof assembly may further include a second panel including a second lower sheet and a second plurality of roof bows coupled to an exterior surface of the second lower sheet. Illustratively, the first panel may include a first number of roof bows different than a second number of roof bows of the second panel.

In another illustrative embodiment, each of the plurality of roof bows may be exposed to an exterior surface of the trailer.

According to yet another aspect of the present disclosure, a roof assembly for a storage container, such as a truck trailer, includes a lower, generally planar sheet having an interior surface configured to face toward a storage space of the storage container. Illustratively, the interior surface of the sheet is generally devoid of structures depending downwardly therefrom. The roof assembly further includes an exterior support structure coupled to the sheet to define a channel between an exterior surface of the sheet and a portion of the exterior support structure. Illustratively, the channel is configured to extend along a width of the roof assembly to define a longitudinal axis perpendicular to a length of the roof assembly, and a height of the channel changes along the longitudinal axis of the channel.

According to still another aspect of the present disclosure, a storage container such as a trailer, for example, includes first and second sidewall assemblies spaced-apart from each other, a front end wall assembly coupled to each of the first and second sidewall assemblies, a rear end wall assembly coupled to each of the first and second sidewall assemblies, and a roof assembly coupled to the first and second sidewall assemblies, the front end wall assembly, and the rear end wall assembly in order to define a storage space therein. Illustratively, the roof assembly includes (i) a lower sheet having a generally planar interior surface facing toward the storage space, and (ii) a plurality of exterior support structures coupled to an exterior surface of the lower sheet. Further illustratively, each exterior support structure is configured to extend across a width of the roof assembly from the first sidewall assembly to the second sidewall assembly. A height of each exterior support structure defines a first height at a longitudinal centerline of the roof assembly that is different than a second height at a peripheral end of the roof assembly.

According to yet another aspect of the present disclosure, a storage container, such as a trailer, for example, includes first and second sidewall assemblies spaced-apart from each other, a front end wall assembly coupled to each of the first and second sidewall assemblies, and a rear end wall assembly coupled to each of the first and second sidewall assemblies. The storage container further includes a roof assembly coupled to the first and second sidewall assemblies, the front end wall assembly, and the rear end wall assembly in order to define a storage space therein. The illustrative roof assembly includes a composite panel having a plurality of corrugations formed therein. Each corrugation of the plurality of corrugations extends across a width of the storage container from the first sidewall to the second sidewall. The composite panel includes a plastic core, an inner metal skin coupled to an inner surface of the plastic core, and an outer metal skin coupled to an outer surface of the plastic core. Illustratively, substantially an entire outer surface of the outer metal skin is exposed to the surrounding environment. Further illustratively, substantially an entire inner surface of the inner metal skin is exposed to the storage space.

### BRIEF DESCRIPTION OF THE DRAWINGS

FIG. 1 is a rear, perspective view of a portion of a truck trailer including a corrugated roof assembly of the present disclosure.

FIG. 2 is a perspective view of a portion of the roof assembly shown in FIG. 1.

FIG. 3 is an end view of a portion of the roof assembly of FIGS. 1 and 2 showing the composite material of the roof assembly.

FIG. 4 is a perspective view of a portion of an alternative roof assembly of the present disclosure.

FIG. 5 is a perspective view of a portion of yet another alternative roof assembly of the present disclosure.

FIG. 6 is a perspective view of a portion of still another alternative roof assembly of the present disclosure.

FIG. 7 is an enlarged end view of a portion of the roof assembly of FIG. 6.

FIG. 8 is a perspective view of a portion of yet another alternative roof assembly of the present disclosure.

FIG. 9 is a perspective view of a portion of still another alternative roof assembly of the present disclosure.

FIG. 10 is a bottom view of one of the external roof bows of the roof assembly of FIG. 9.

FIG. 11 is a side view of the external roof bow of FIG. 10.

FIG. 12 is a perspective view of a portion of yet another alternative roof assembly of the present disclosure.

FIG. 13 is a bottom view of one of the external roof bows of the roof assembly of FIG. 12.

FIG. 14 is a side view of the external roof bow of FIG. 13.

FIG. 15 is a rear, perspective view of a portion of another truck trailer including an alternative corrugated roof assembly of the present disclosure.

FIG. 16 is a sectional view of the corrugated roof assembly of FIG. 15 taken along lines 16-16 of FIG. 15.

FIG. 17 is a sectional view of the corrugated roof assembly of FIGS. 15 and 16 taken along line 17-17 of FIG. 15.

FIG. 18 is a perspective view of two panels of the roof assembly of FIGS. 1-3 showing a mechanical joint coupling the two panels together.

### DESCRIPTION OF THE ILLUSTRATIVE EMBODIMENTS

For the purposes of promoting an understanding of the principles of the invention, reference will now be made to illustrative embodiments shown in the attached drawings and specific language will be used to describe the same. While the concepts of this disclosure are described in relation to a truck trailer, it will be understood that they are equally applicable to other mobile or stationary storage containers, as well as refrigerated and un-refrigerated trailers or storage containers.

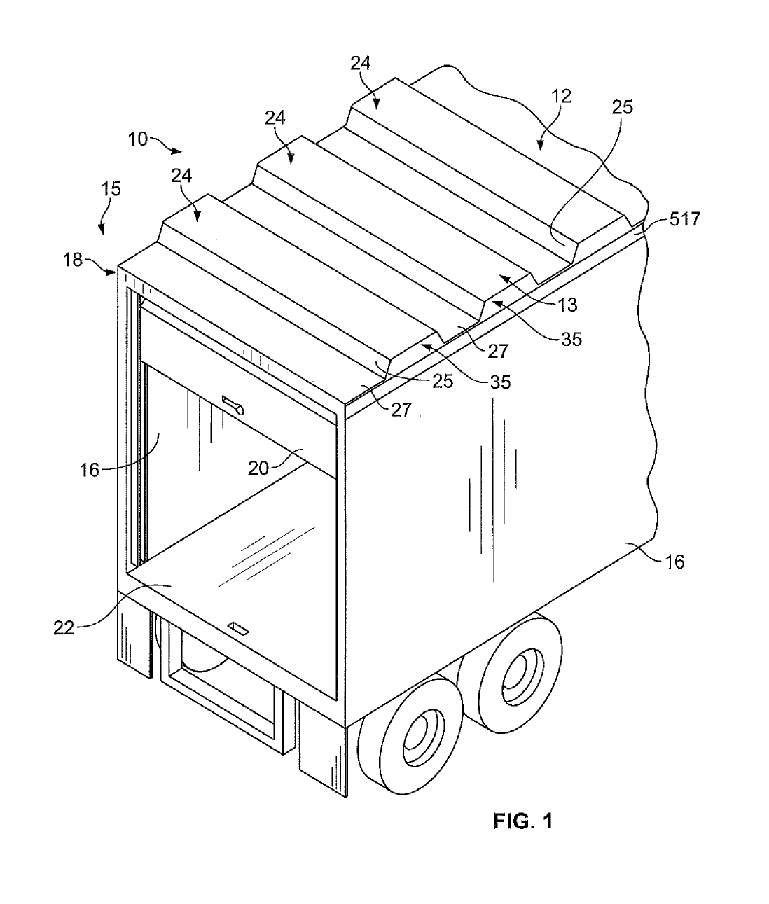

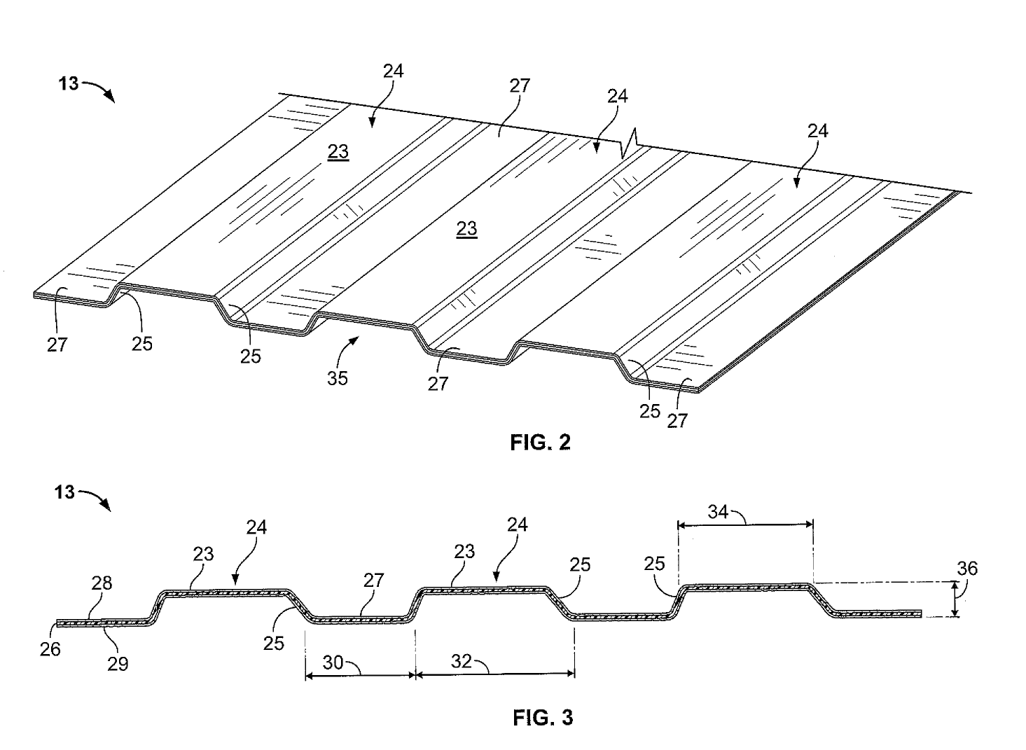

Looking first to FIGS. 1-3, a truck trailer 10 includes a roof assembly 12 coupled to opposite sidewalls 16 and an end wall assembly 18 including an overhead door 20. Illustratively, the trailer 10 also includes a floor assembly 22 spaced apart from the roof assembly 12. Illustratively, the roof assembly 12 is made from a panel 13 including corrugations 24 extending across the width (from side to side) of the trailer 10. In other words, the longitudinal axis of each corrugation 24 is transverse to the longitudinal axis of the trailer 10. The corrugations 24 operate to provide stiffness to the roof assembly 12 in order to reinforce and strengthen the roof assembly 12. Illustratively, each corrugation 24 includes a top wall 23 and outer side walls 25 coupled to each side of the top wall 23. As shown in FIGS. 2 and 3, the side walls 25 are angled outwardly at a bottom end away from the top wall 23. It is within the scope of this disclosure, however, for each corrugation 24 to include side walls 25 which are angled inwardly at a bottom end toward the top wall 23 and/or which are generally perpendicular to the top wall 23 such that the side walls 25 extend generally vertically downwardly from the top wall 23. Each corrugation 24 is coupled to a planar member or base wall 27 such that the panel 13 includes a plurality of alternating base walls 27 and corrugations 24. Accordingly, each side wall 25 is coupled to one of the base walls 27, as shown in FIG. 2.

Illustratively, the roof assembly 12 including the corrugations 24 may be coupled to the sidewalls 16 of the trailer 10 in a number of ways. For example, the ends of each base wall 27 may be fixed to an upper edge of each respective sidewall 16 of the trailer. Illustratively, the sidewalls 16 each include a top rail 517 which extends along a length of the trailer 10. Thus, the roof assembly 12 may be coupled to the top rail 517 of each sidewall 16. Illustratively, a cavity 35 between the upper edge of each sidewall 16 and the top wall 23 of each corrugation 24 may remain empty or may be filled with dimension conforming blanking plugs (not shown), for example. Such blanking plugs may be made from any suitable material including plastics, metals, metal alloys, foam, and/or wood, for example. Alternatively, and as shown similarly in FIGS. 15-17 of the present disclosure, the corrugations 24 may be configured to progressively flatten outwardly from a longitudinal centerline 531 of the roof assembly 12 towards the upper edges of the sidewall 16 thereby providing a continuous, generally planar edge of the roof assembly 12 to be coupled in a conventional manner to the upper edges of the sidewalls 16.

Illustratively, the roof assembly 12 may be made from a single panel 13 extending generally from the rear end 15 of the trailer 10 to the front end (not shown) of the trailer 10. In other words, the single panel 13 of the roof assembly 12 may be coupled to both the end frame assembly 18 and a front frame assembly (not shown). Alternatively, the roof assembly 12 may be made from any suitable number of panels including the alternating corrugations 24 and base walls 27. For example, the roof assembly 12 may be made from three panels, such as the panel 13 shown in FIG. 2.

Each panel 13 may be coupled to an adjacent panel 13 through the use of an adhesive material and/or mechanical fasteners, such as rivets, nails, screws, bolts, welds, etc. Further illustratively, each panel 13 may be coupled to an adjacent panel 13 using a mechanical formed joint such as that illustratively shown in FIG. 18, for example. As shown in FIG. 18, adjacent panels 13 each include a hook portion 33 formed along each longitudinal side of the panels 13. In other words, the hook portions 33 extend parallel to the corrugations 24 of the panels 13. As shown, the hook portion 33 at a first end of one of the adjacent panels 13 curves upwardly while the hook portion 33 at a second end of the other one of the adjacent panels 13 curves downwardly such that the two hook portions 33 of the adjacent panels 13 are configured to interlock with each other to form the mechanical joint 37. It should be understood that adjacent panels 13 may be coupled to each other using other suitable mechanical joints as well.

Illustratively, each panel 13 is approximately 102 inches wide (in order to span the width of a typical trailer, such as the trailer 10) and a length of approximately 48 inches. Of course, the panels 13 may be any suitable length or width to suit a storage container of any size. Further illustratively, each panel 13 may include three corrugations 24 spaced-apart by base walls 27. As shown in FIG. 2, for example, the illustrative panel 13 includes two end base walls 27 positioned at each end of the panel 13, and two planar members 27 positioned between the corrugations 24. Illustratively, as shown in FIGS. 2 and 3, a width 30 of each base wall 27 is approximately 5¼ inches while an overall width 32 of each corrugation 24 is approximately 9 inches. Further, a width 34 of the top wall or planar portion 23 of each corrugation 24 is approximately 7 inches. Illustratively, a height 36 of the sheet 13 is approximately 1 inch.

Further illustratively, the roof assembly 12 may include a combination of corrugated panels 13 as well as other roof sections (not shown). In other words, while the roof assembly 12 may include one or more corrugated panels 13 extending the length of the trailer 10, the roof assembly 12 may also include one or more corrugated panels 13 positioned only at specific discrete locations along the length of the roof assembly 12 as needed to satisfy certain performance needs, for example.

The illustrative panel or panels 13 of the roof assembly 12 are each made from a composite material. The illustrative composite material of the panels 13 includes a plastic core 26 and inner and outer metal skins 28, 29 coupled to the plastic core 26, as shown in FIG. 3. Such a composite material provides a rigid, but lightweight and durable material. Illustratively, for example, the panel(s) 13 of the roof assembly 12 may be made of a DURAPLATE® composite panel provided by Wabash National Corporation of Lafayette, Ind. DURAPLATE® composite panels are constructed of a high-density polyethylene plastic core bonded between two high-strength steel skins. Illustratively, the composite material (i.e., panel(s) 13) is approximately 0.10 inch thick. While the illustrative panel(s) 13 of the roof assembly 12 are each made of the particular composite material described above, it should be understood that other suitable composite materials may be used as well.

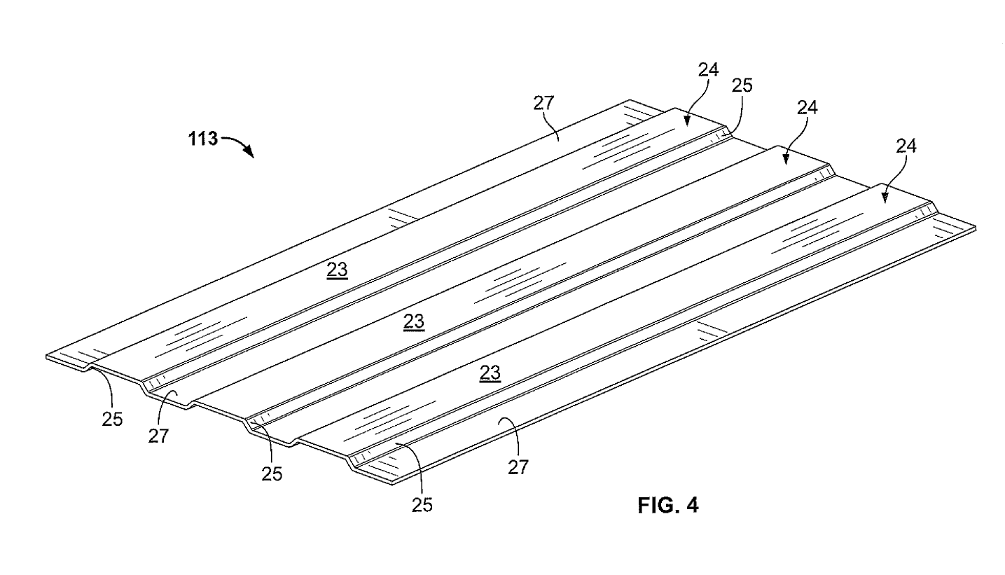

Further illustratively, it is within the scope of this disclosure for the panels 13 to be made from any number of suitable, non-composite materials such as metals, metal alloys, and/or plastics, for example. In particular, an alternative panel 113 may be made from galvanized steel, as shown in FIG. 4, for example. Illustratively, such a steel sheet may be approximately 0.04 inch thick. Of course, it is within the scope of this disclosure to include non-galvanized steel sheets, or other such non-composite panels, of any suitable thickness as well. Further illustratively, the alternative panel 113 includes many of the same or similar components as the panel 13 of FIGS. 1-3. As such, like reference numerals are used to denote like components.

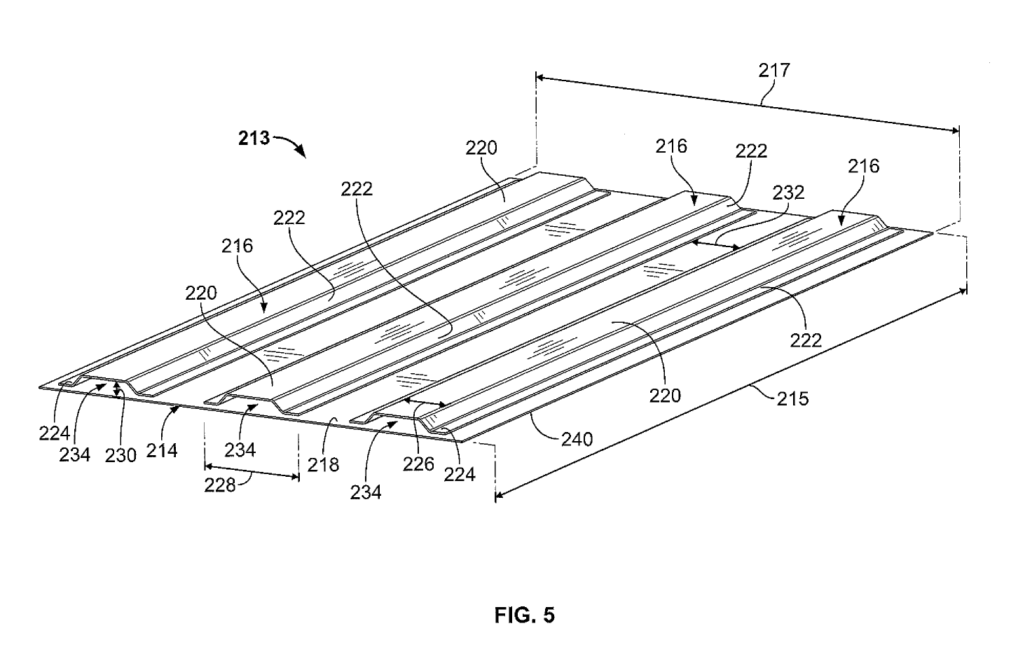

Looking now to FIG. 5, another alternative panel 213 for an alternative roof assembly (not shown) for the trailer 10 is provided. Illustratively, the panel 213 includes a sheet 214 and external roof bows 216 coupled to a top, or exterior, surface 218 the sheet 214. As part of an alternative roof assembly for the trailer 10, the panel 213 is positioned such that the roof bows 216 extend laterally across a width of the trailer 10 in order to strengthen and reinforce the roof assembly of the trailer 10. As such, the roof bows 216 may operate as an exterior support structure.

Illustratively, the sheet 214 is made from a metal, such as steel. However, it is within the scope of this disclosure for the sheet 214 to be made from other suitable metals, non-metals, alloys, and/or composite materials. Illustratively, the sheet 214 is approximately 0.019 inch thick, has a width 215 of approximately 102 inches (in order to span the width of the trailer 10) and a length 217 of approximately 49 inches. It should be understood, however, that the sheet 214 may be any suitable thickness, width, and length. In particular, the sheet may alternatively be 0.013 inch thick.

Each roof bow 216 of the panel 213 is also made from a metal, such as steel. However, it is within the scope of this disclosure for the roof bows 216 to be made from other suitable metals, non-metals, alloys, and/or composite materials. Illustratively, the panel 213 includes three roof bows 216, however, any suitable number of roof bows may be used. Illustratively, each roof bow 216 includes a top wall 220 spaced-apart from the sheet 214, two angled side walls 222 coupled to either side of the top wall 220, and a planar flange 224 coupled to each of the angled side walls 222. Similar to the angled side walls 25 of the panel 13, the side walls 222 are oriented to angle outwardly away from the top wall 220. Illustratively, a width 226 of the top wall 220 is approximately 5 inches while an overall width 228 of each roof bow 216 is approximately 11 inches. Further illustratively, a height 230 of each roof bow 216 is approximately 1 inch. Illustratively, as is discussed in greater detail in regards to FIGS. 9-14, the height 230 of each roof bow 216 may decrease from a first height taken near a longitudinal centerline 513 of the roof assembly 12 to a lesser, second height taken at or near the side ends of the roof assembly 12. In particular, the first height may be approximately 1.0 inch while the second height may be approximately 0.24 inch. Further illustratively, a thickness 234 of each roof bow is approximately 0.019 inch. It should be understood, however, that a roof bow of any suitable dimension may be used as well. In particular, a roof bow having a thickness of approximately 0.013 inch may be used as well.

Illustratively, the roof bows 216 of the panel 213 are spaced-apart from each other such that the flanges 224 of two adjacent roof bows 216 are not engaged with each other. In particular, a distance 232 between two illustrative roof bows 216 of the panel 213 is approximately 13.5 inches. It should be understood, however, that the roof bows 216 may be spaced any suitable distance apart from each other. Further, the spacing between the roof bows 216 may be regular and/or irregular. In other words, the spacing between two adjacent roof bows 216 on a single panel 213 may be the same as or different from the spacing between two other adjacent roof bows 216 on the same panel 213. Further, it is within the scope of this disclosure for the flanges 224 of two adjacent roof bows 216 of the panel 213 to engage each other as well.

The roof bows 216 may be coupled to the upper, or exterior, surface 218 of the sheet 214 in a number of ways. For example, the roof bows 216 may be coupled to the upper surface 218 of the sheet 214 through the use of structural adhesives, welding, and/or other mechanical fasteners such as rivets, nails, screws, bolts, and the like.

Illustratively, the panel 213 includes a transverse cavity 234 between each roof bow 216 and the upper surface 218 of the sheet 214. In particular, each cavity 234 is defined by the top wall 220 of each roof bow 216, the angled side walls 222 of each roof bow 216, and a portion of the upper surface 218 of the sheet 214. Each cavity 234 is configured to extend transversely across the width of the trailer 10. Illustratively, a cross-sectional shape of each cavity generally defines a trapezoid due to the trapezoidal cross-sectional shape of the bows 216 themselves. It should be understood, however, that the roof bows 216, and thus the cavities 234 formed by the roof bows 216, may define any other suitable cross-sectional shape as well.

Illustratively, the cavities 234 of each panel 213 may remain empty. Alternatively, the cavities 234 may be filled with a lightweight foam (not shown). This foam may operate to in conjunction with, or as an alternative to, other means by which the sheet 214 and the roof bows 216 are coupled to one another. In particular, the foam may be configured to bond with both the roof bows 216 and the sheet 214. Furthermore, the foam operates to provide increased structural rigidity of the roof assembly 12 while minimizing the overall weight of the roof assembly. It should be understood, however, that while the cavity 234 formed by each roof bow 216 may be filled with a foam material, these cavities 234 may be filled with other suitable materials as well.

In use as part of a roof assembly (not shown) on a trailer, such as the trailer 10, the panel 213 is oriented such that a lower surface 240 of the sheet 214 of the panel 213 faces downwardly into the interior (not shown) of the trailer 10. In particular, the lower surface 240 of the sheet 214 forms a smooth, inner roof surface of the interior storage space (not shown) of the trailer. Accordingly, such a smooth, inner roof surface does not include any downwardly extending support structures which may intrude upon the overall height of the storage space. Further, such a smooth, inner roof surface provides a surface free from protrusions that may be inadvertently hit by cargo during loading and/or unloading of cargo to and from the storage space, thus potentially damaging the cargo.

As noted above in regard to the panel 13, any number of panels 213 may be used to create a single roof assembly for a trailer, such as the trailer 10. Alternatively, a single elongated panel 213 may be used as well. Further alternatively, one or more panels 213 may be used in conjunction with one or more other roof panels to create a customized roof assembly for the trailer 10. As noted above, the panels 213 may be selectively placed along the length of the trailer 10 to satisfy certain performance needs or desires, for example.

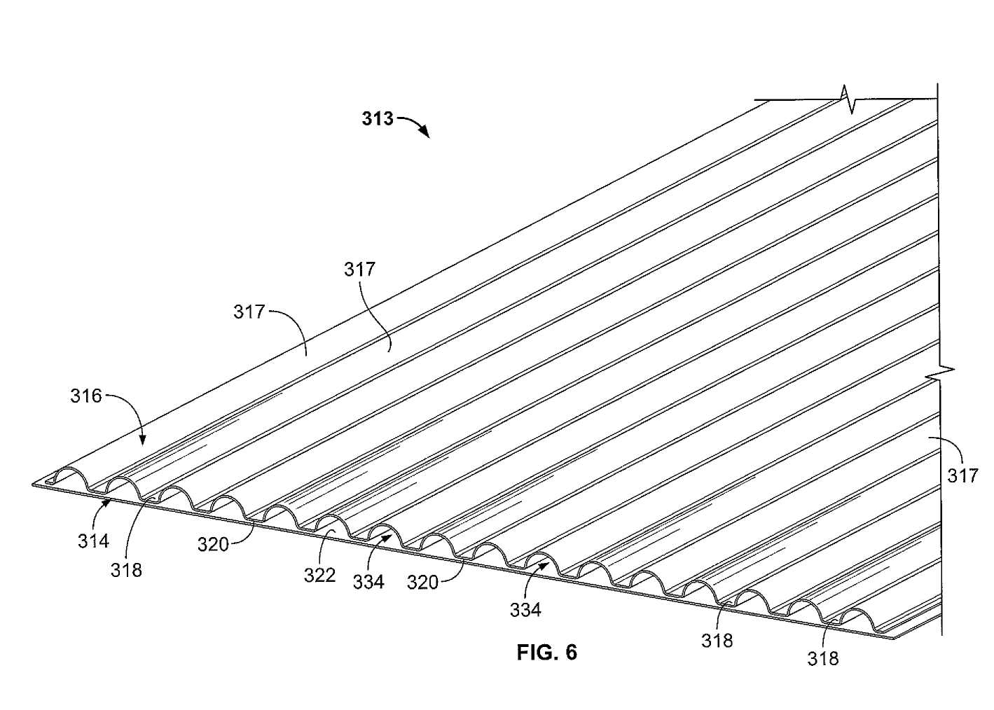

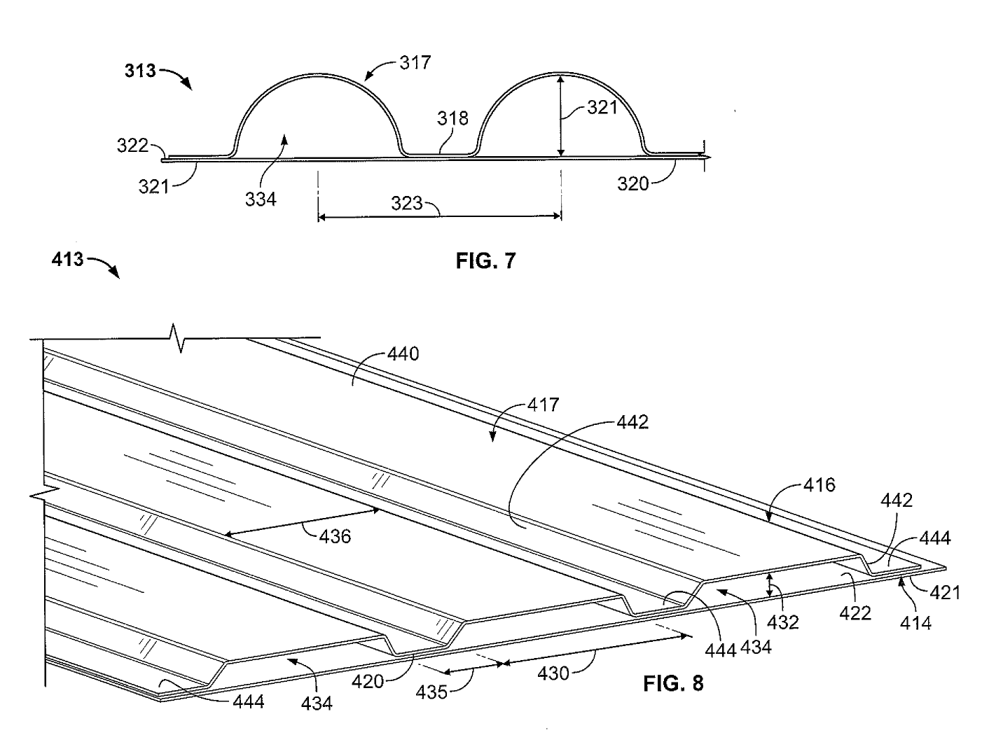

Looking now to FIGS. 6 and 7, another panel 313 for an alternative roof assembly (not shown) for the trailer 10 is provided. Illustratively, the panel 313 includes a lower sheet 314 and an upper sheet 316 coupled to the lower sheet 314. As is discussed in greater detail below, the upper sheet 316 is corrugated. Further illustratively, as part of an alternative roof assembly for the trailer 10, the panel 313 is positioned such that the corrugations 317 of the upper sheet 316 extend laterally across a width of the trailer 10 in order to strengthen and reinforce the roof assembly 12 of the trailer 10. Illustratively, while the panel 313 includes the upper corrugated sheet 316 and the lower, planar sheet 2314, it should be understood that a roof assembly may be provided including only the upper corrugated sheet 316 without the lower sheet 314.

Illustratively, the lower sheet 314 is made from a metal, such as steel. However, it is within the scope of this disclosure for the lower sheet 314 to be made from other suitable metals, non-metals, alloys, and/or composite materials. Illustratively, the lower sheet 314 is approximately 0.016 inch thick, approximately 102 inches wide (in order to span the width of the trailer 10) and approximately 49 inches long. It should be understood, however, that the lower sheet 314 may be any suitable thickness, width, and length to fit any trailer or storage container. In particular, the lower sheet may alternatively be 0.019 inch thick.

As noted above, the upper sheet 316 is corrugated to include curved walls, or corrugations, 317 configured to extend across a width of the trailer 10. The curved walls 317 include a middle portion which is generally spaced apart from the lower sheet 314. Similar to the lower sheet 314, the upper sheet 316 is made from a metal, such as steel. However, it is within the scope of this disclosure for the upper sheet 316 to be made from other suitable metals, non-metals, alloys, and/or composite materials. Illustratively, the upper sheet 316 is approximately 0.016 inch thick, approximately 102 inches wide, and approximately 49 inches long. It should be understood, however, that the upper sheet 316 may be any suitable thickness, width, and length. In particular, the sheet 316 may alternatively be 0.019 inch thick.

In addition to the curved walls 317, the upper sheet 316 further includes generally planar member or base wall 318 between each curved wall 317. As such, the upper sheet 316 includes a plurality of alternating base walls 318 and corrugations 317. Illustratively, as is described below, a bottom surface 320 of each base wall 318 of the upper sheet 316 is adjacent to and engaged with an upper, or exterior, surface 322 of the lower sheet 314. Looking now to FIG. 7, the cross-section of each curved wall 317 generally defines a semi-circle. It is within the scope of this disclosure, however, for the upper sheet 316 to include corrugations having any suitable cross-sectional curved or angular shape. Illustratively, the radius of each curved section 317 is approximately 1.0 inch such that a height 321 of each curved section 317 of the upper sheet 316 is approximately 1.0 inch. Further illustratively, a distance 323 between the center of adjacent curved sections 317 is approximately 1.5 inches. Of course, it should be understood that the upper sheet 316 may include any suitable dimensions of and between the corrugated sections 317.

The upper sheet 316 and the lower sheet 314 may be coupled to each other in a number of ways. For example, the lower surface 320 of the base walls 318 of the upper sheet 316 may be coupled to the upper surface 322 of the lower sheet 314 through the use of structural adhesives, welding, and/or mechanical fasteners such as rivets, nails, screws, bolts, and the like. Of course, other suitable fasteners and/or fastening means, including mechanical joints such as joint 37 shown in FIG. 18, may be used as well.

Illustratively, the upper sheet 316 and the lower sheet 314 of the panel 313 cooperate to define a transverse cavity 334 between each curved section 317 of the upper sheet 316 and the upper surface 322 of the lower sheet 314. Each cavity 334 is configured to extend transversely across the width of the trailer 10. Illustratively, the cavities 334 of each panel 313 may remain empty. Alternatively, the cavities 334 may be filled with a lightweight foam (not shown). This foam may operate in conjunction with, or as an alternative to, other means by which the sheets 314 and 316 are coupled to one another. In particular, the foam may be configured to bond with both curved sections 317 of the upper sheet 316 and the lower sheet 314. It should be understood, however, that while the cavity 334 formed by each curved section 317 may be filled with a foam material, these cavities 334 may be filled with other suitable materials as well.

In use as part of a roof assembly (not shown) on a trailer, such as the trailer 10, the panel 313 is oriented such that the lower, or interior, surface 321 of the lower sheet 314 of the panel 313 faces downwardly into the interior (not shown) of the trailer 10. In particular, the lower surface 321 of the sheet 314 forms a smooth, inner roof surface of the interior storage space (not shown) of the trailer. Accordingly, such a smooth, inner roof surface does not include any downwardly extending support structures which may intrude upon the overall height of the storage space. Further, such a smooth, inner roof surface provides a surface free from protrusions that may be inadvertently hit by cargo during loading and/or unloading of cargo to and from the storage space, thus potentially damaging the cargo. Further, the panel 313 is oriented such that the curved sections 317 of the upper sheet 316 extend transversely across a width of the trailer 10. As noted above in regards to the panels 13, 113, and 213, any number of panels 313 may be used to create a single roof assembly for a trailer, such as the trailer 10. Alternatively, a single elongated panel 313 may be used as well. Further alternatively, one or more panels 313 may be used in conjunction with one or more other panels to create a roof assembly for the trailer 10. As noted above, the panels 313 may be selectively placed along the length of the trailer 10 to satisfy certain performance needs or desires.

Looking now to FIG. 8, another panel 413 for an alternative roof assembly (not shown) for the trailer is provided. Illustratively, the panel 413 includes a lower sheet 414 and an upper sheet 416 coupled to the lower sheet 414. As is discussed in greater detail below, the upper sheet 416 is corrugated. Further illustratively, as part of an alternative roof assembly for the trailer 10, the panel 413 is positioned such that the corrugations 417 of the upper sheet 416 extend laterally across a width of the trailer 10 in order to strengthen and reinforce the roof assembly 12 of the trailer 10.

Illustratively, the lower sheet 414 is made from a metal, such as steel. However, it is within the scope of this disclosure for the lower sheet 414 to be made from other suitable metals, non-metals, alloys, and/or composite materials. Illustratively, the lower sheet 414 is approximately 0.016 inch thick, approximately 102 inches wide (in order to span the width of the trailer 10) and approximately 49 inches long. It should be understood, however, that the lower sheet 414 may be any suitable thickness, width, and length to fit any trailer or storage container. In particular, the lower sheet may alternatively be 0.019 inch thick.

As noted above, the upper sheet 416 is corrugated to include corrugations 417 configured to extend across a width of the trailer 10. Similar to the lower sheet 414, the upper sheet 416 is made from a metal, such as steel. However, it is within the scope of this disclosure for the upper sheet 416 to be made from other suitable metals, non-metals, alloys, and/or composite materials. Illustratively, the upper sheet 416 is approximately 0.016 inch thick, approximately 102 inches wide, and approximately 49 inches long. It should be understood, however, that the upper sheet 416 may be any suitable thickness, width, and length. In particular, the sheet may alternatively be 0.019 inch thick.

Illustratively, each corrugation 417 includes a top wall 440 spaced-apart from the lower sheet 414 and two angled side walls 442 coupled to each side of the top wall 440. The side walls 442 are angled outwardly at a bottom end away from the top wall 440. In addition to the corrugations 417, the upper sheet 416 further includes generally planar base walls 444 between each corrugation 417 such that the upper sheet 416 includes a plurality of alternating base walls 444 and corrugations 417. Illustratively, as is described below, a bottom surface 420 of each base wall 444 of the upper sheet 416 is adjacent to and engaged with an upper, or exterior, surface 422 of the lower sheet 414. Illustratively, the cross-sectional shape of each corrugation 417 generally defines a trapezoid. It is within the scope of this disclosure, however, for the upper sheet 416 to include corrugations having any suitable cross-sectional curved or angular shape. Illustratively, a width 430 of each corrugation 417 is approximately 11.75 inches and a height 432 of each corrugation 417 of the upper sheet 416 is approximately 1.0 inch. Further illustratively, a width 435 of each base wall 444 is approximately 3.19 inches while a width 436 of the top wall 440 of each corrugation 417 is approximately 5.0 inches. Of course, it should be understood that the upper sheet 416 may include any suitable dimensions of and between the corrugated sections 417.

The upper sheet 416 and the lower sheet 414 may be coupled to each other in a number of ways. For example, the lower surface 420 of the base walls 444 of the upper sheet 416 may be coupled to the upper surface 422 of the lower sheet 414 through the use of structural adhesives, welding, and/or mechanical fasteners such as rivets, nails, screws, bolts, and the like. Of course, other suitable fasteners and/or fastening means, including joints such as the joint 37 shown in FIG. 18, may be used as well.

Illustratively, the upper sheet 416 and the lower sheet 414 of the panel 413 cooperate to define a transverse cavity 434 between each curved section 417 of the upper sheet 416 and the upper surface 422 of the lower sheet 414. Each cavity 434 is configured to extend transversely across the width of the trailer 10 and defines a generally trapezoidal cross-sectional shape. Illustratively, the cavities 434 of each panel 413 may remain empty. Alternatively, the cavities 434 may fill with a lightweight foam (not shown). This foam may operate to in conjunction with, or as an alternative to, other means by which the sheets 414 and 416 are coupled to one another. In particular, the foam may be configured to bond with both corrugations 417 of the upper sheet 416 and the lower sheet 414. It should be understood, however, that while the cavity 434 formed by each corrugation 417 may be filled with a foam material, these cavities 434 may be filled with other suitable materials as well.

In use as part of a roof assembly (not shown) on a trailer, such as the trailer 10, the panel 413 is oriented such that the lower, or exterior, surface 421 of the lower sheet 414 of the panel 413 faces downwardly into the interior (not shown) of the trailer 10. In particular, the lower surface 421 of the sheet 414 forms a smooth, inner roof surface of the interior storage space (not shown) of the trailer. Accordingly, such a smooth, inner roof surface does not include any downwardly extending support structures which may intrude upon the overall height of the storage space. Further, such a smooth, inner roof surface provides a surface free from protrusions that may be inadvertently hit by cargo during loading and/or unloading of cargo to and from the storage space, thus potentially damaging the cargo. Further, the panel 413 is oriented such that the corrugations 417 of the upper sheet 416 extend transversely across a width of the trailer 10. As noted above in regards to the panels 13, 113, 213, and 313, any number of panels 413 may be used to create a single roof assembly for a trailer, such as the trailer 10. Alternatively, a single elongated panel 413 may be used as well. Further alternatively, one or more panels 413 may be used in conjunction with one or more other panels to create a roof assembly for the trailer 10. As noted above, the panels 413 may be selectively placed along the length of the trailer 10 to satisfy certain performance needs or desires.

Looking now to FIGS. 9-11, another alternative roof assembly 512 for the trailer 10 includes a first panel 513 and a second panel 515 adjacent the first panel 513. Each panel is illustratively coupled to upper frame members 517 of each respective side wall 16 of the trailer 10. Illustratively, each panel 513, 515 includes a lower sheet 514 and an external roof bows 516 coupled to a top, or exterior, surface 518 of the sheet 514. The panels 513, 515 are positioned such that the roof bows 516 extend laterally across a width of the trailer 10 in order to strengthen and reinforce the roof assembly 512 of the trailer 10.

Illustratively, each sheet 514 is made from a metal, such as steel. However, it is within the scope of this disclosure for each sheet 514 to be made from other suitable metals, non-metals, alloys, and/or composite materials. Illustratively, the sheet 514 is approximately 0.019 inch thick, has a width 519 of approximately 102 inches (in order to span the width of the trailer 10) and a length 521 of approximately 49 inches. It should be understood, however, that the sheet 514 may be any suitable thickness, width, and length.

The roof bows 516 of each panel 513, 515 are also made from a metal, such as steel. However, it is within the scope of this disclosure for the roof bows 516 to be made from other suitable metals, non-metals, alloys, and/or composite materials. Illustratively, the first panel 513 includes two roof bows 516 while the second panel 515 includes three roof bows 516. As such, it should be understood that a panel of the roof assembly 512 may include any suitable number of roof bows 516 coupled thereto. Further, the roof bows 516 may be spaced any suitable distance apart from each other and apart from the front and rear ends of the lower sheet 514. Illustratively, the roof bows 516 may be coupled to the upper surface 518 of the sheet 514 in a number of ways. For example, the roof bows 516 may be coupled to the upper surface 518 of the sheet 514 through the use of structural adhesives, welding, and/or other mechanical fasteners such as rivets, nails, screws, bolts, and the like.

Illustratively, each roof bow 516 includes a top wall 520 spaced-apart from the sheet 514, two angled side walls 522 coupled to either side of the top wall 520, and a planar flange 524 coupled to each of the angle side walls 522. Similar to the angled side walls 222 of the panel 213, the side walls 522 are oriented to angle outwardly away from the top wall 520.

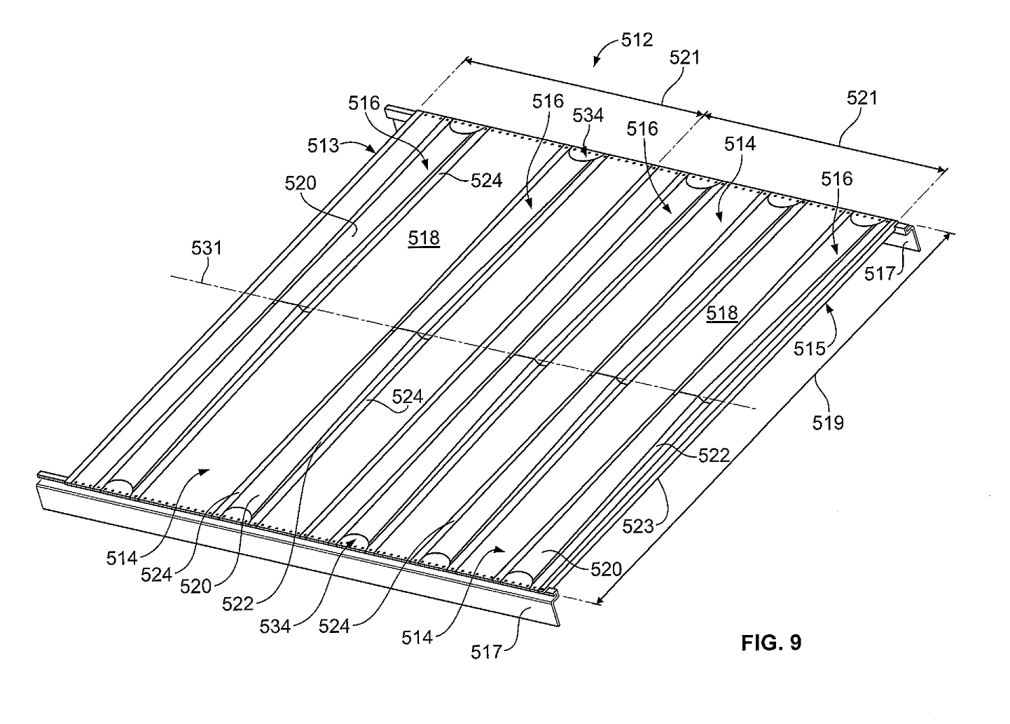

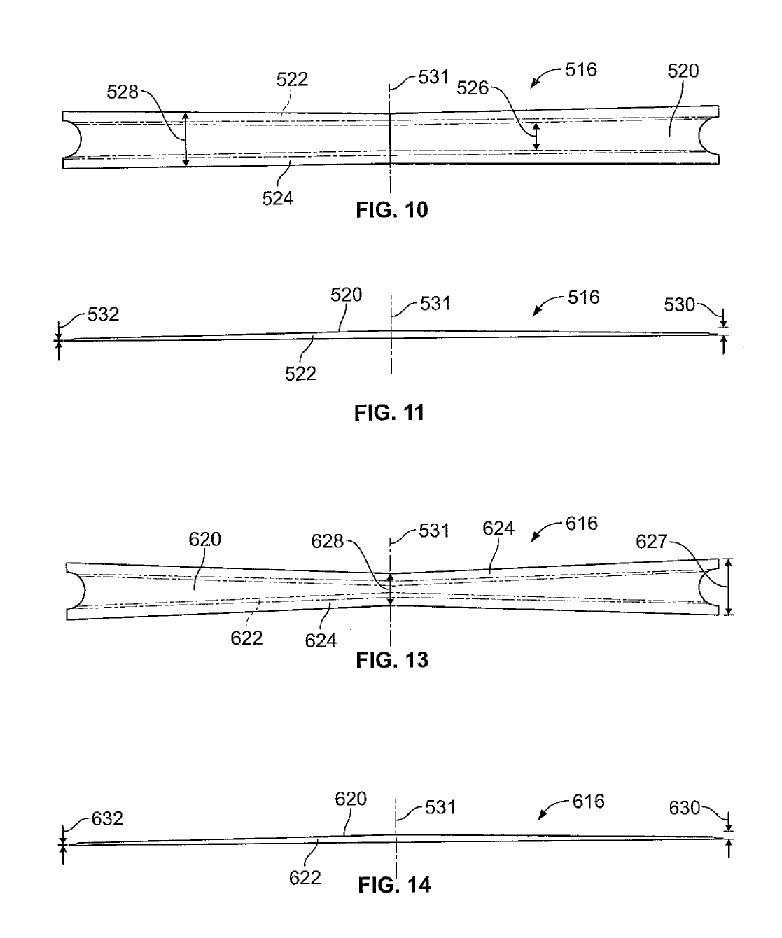

Illustratively, a width 526 of the top wall 520 is approximately 5 inches while an overall width 528 of each roof bow 516 is approximately 11 inches. Further, illustratively, a centerline height 530 of each roof bow 516 taken at or near the longitudinal centerline 531 of the roof assembly 512 is approximately 1 inch. Illustratively, the longitudinal centerline 531 of the roof assembly 512 is parallel to the longitudinal centerline of the trailer 10. In other words, the longitudinal centerline 531 runs along a length of the trailer 10 from a front end of the trailer 10 to a rear end of the trailer 10 and is generally perpendicular to a longitudinal axis (not shown) of each of the roof bows 516. The height of each roof bow 516 decreases from the centerline height 530 to a second, peripheral height 532 taken at or near the side, or peripheral, ends of the roof assembly 512, as shown in FIG. 11. Illustratively, each peripheral end of the roof assembly 512 is coupled to one of the sidewalls 16 of the trailer 10. In particular, the peripheral height 532 may be approximately 0.24 inch. As shown in FIG. 11, the height of each roof bow 516 gradually decreases when moving outwardly from the centerline height 530 of approximately 1 inch to the peripheral height 532 of approximately 0.24 inch. In other words, the height of each roof bow 516 changes along the longitudinal axis of each roof bow 516. As shown in FIGS. 9 and 10, as the height of each roof bow 516 gradually decreases, the height of the side walls 522 similarly decreases. Finally, illustratively, a thickness (not shown) of each roof bow is approximately 0.019 inch. It should be understood, however, that a roof bow having other suitable dimensions may be used as well.

Similar to the roof bows 216 shown in FIG. 5, the roof bows 516 of the roof assembly 512 are spaced-apart from each other such that the flanges 524 of two adjacent roof bows 516 are not engaged with each other. As noted above, the roof bows 516 may be spaced any suitable distance apart from each other and the distance between any two adjacent roof bows 516 need not be the same. In other words, the spacing between the roof bows 516 may be regular and/or irregular. Further, it is within the scope of this disclosure for the flanges 524 of two adjacent roof bows 516 to engage each other as well.

Illustratively, the panels 513, 515 each include a transverse cavity, or channel, 534 between the top and side walls 520, 522 of each roof bow 516 and the upper surface 518 of the sheet 514. Each cavity 534 is configured to extend transversely across the width of the trailer 10 to define a longitudinal axis perpendicular to a length of the of the roof assembly. Illustratively, a cross-sectional shape of each cavity generally defines a trapezoid due to the trapezoidal cross-sectional shape of the bows 516 themselves. It should be understood, however, that the roof bows 516, and thus the cavities 534 formed by the roof bows 516, may define any other suitable cross-sectional shape as well.

Illustratively, the cavities 534 of each panel 513, 515 may remain empty. Alternatively, the cavities 534 may be filled with a lightweight foam (not shown). This foam may operate to in conjunction with, or as an alternative to, other means by which the sheet 514 and the roof bows 516 are coupled to one another. In particular, the foam may be configured to bond with both the roof bows 516 and the sheet 514. Furthermore, the foam operates to provide increased structural rigidity of the roof assembly 512 while minimizing the overall weight of the roof assembly 512. It should be understood, however, that while the cavity 534 formed by each roof bow 516 may be filled with a foam material, these cavities 534 may be filled with other suitable materials as well.

In use, the panels 513, 515 of the roof assembly 512 are oriented such that a lower, or interior, surface (not shown) of the sheets 514 faces downwardly into the interior (not shown) of the trailer 10. In particular, the lower, or interior, surface 523 of the sheets 514 forms a smooth, inner roof surface of the interior storage space (not shown) of the trailer. Accordingly, such a smooth, inner roof surface does not include any downwardly extending support structures which may intrude upon the overall height of the storage space. Further, such a smooth, inner roof surface provides a surface free from protrusions that may be inadvertently hit by cargo during loading and/or unloading of cargo to and from the storage space, thus potentially damaging the cargo.

As noted above in regards to previously-described panels, any number of panels 513, 515 may be used to create a single roof assembly for a trailer, such as the trailer 10. Alternatively, a single elongated panel may be used as well. Further alternatively, one or more panels 513, 515 may be used in conjunction with one or more other roof panels to create a customized roof assembly for the trailer 10. In particular, one or more panels 513, 515 may be selectively placed along the length of the trailer 10 to satisfy certain performance needs or desires, for example.

Looking now to FIGS. 12-14, another alternative roof assembly 612 for the trailer 10 includes a first panel 613 and a second panel 615 adjacent the first panel 613. Each panel is illustratively coupled to upper frame members 517 of each respective side wall 16 of the trailer 10. Illustratively, each panel 613, 615 includes a lower sheet 614 and external roof bows 616 coupled to a top, or exterior, surface 618 of the sheet 614. The panels 613, 615 are positioned such that the roof bows 616 extend laterally across a width of the trailer 10 in order to strengthen and reinforce the roof assembly 612 of the trailer 10.

Illustratively, each sheet 614, similar to the sheets 514 described above, is made from a metal, such as steel. However, it is within the scope of this disclosure for the sheet 614 to be made from other suitable metals, non-metals, alloys, and/or composite materials. Illustratively, the sheet 614 is approximately 0.019 inch thick, has a width 619 of approximately 102 inches (in order to span the width of the trailer 10) and a length 621 of approximately 49 inches. It should be understood, however, that the sheet 614 may be any suitable thickness, width, and length.

The roof bows 616 of each panel 613, 615 are also made from a metal, such as steel. However, it is within the scope of this disclosure for the roof bows 516 to be made from other suitable metals, non-metals, alloys, and/or composite materials. Illustratively, the first panel 613 includes two roof bows 616 while the second panel 615 includes three roof bows 616. As such, it should be understood that a panel of the roof assembly 612 may include any suitable number of roof bows 616 coupled thereto. Further, the roof bows 616 may be spaced any suitable distance apart from each other and apart from the front and rear ends of the lower sheet 614. Illustratively, the roof bows 616 may be coupled to the upper surface 618 of the sheet 614 in a number of ways. For example, the roof bows 616 may be coupled to the upper surface 618 of the sheet 614 through the use of structural adhesives, welding, and/or other mechanical fasteners such as rivets, nails, screws, bolts, and the like.

Illustratively, each roof bow 616 includes a top wall 620 spaced-apart from the sheet 614, two angled side walls 622 coupled to either side of the top wall 620, and a planar flange 624 coupled to each of the angle side walls 622. Similar to the angled side walls 522 of the panel 513, the side walls 622 are oriented to angle outwardly away from the top wall 620.

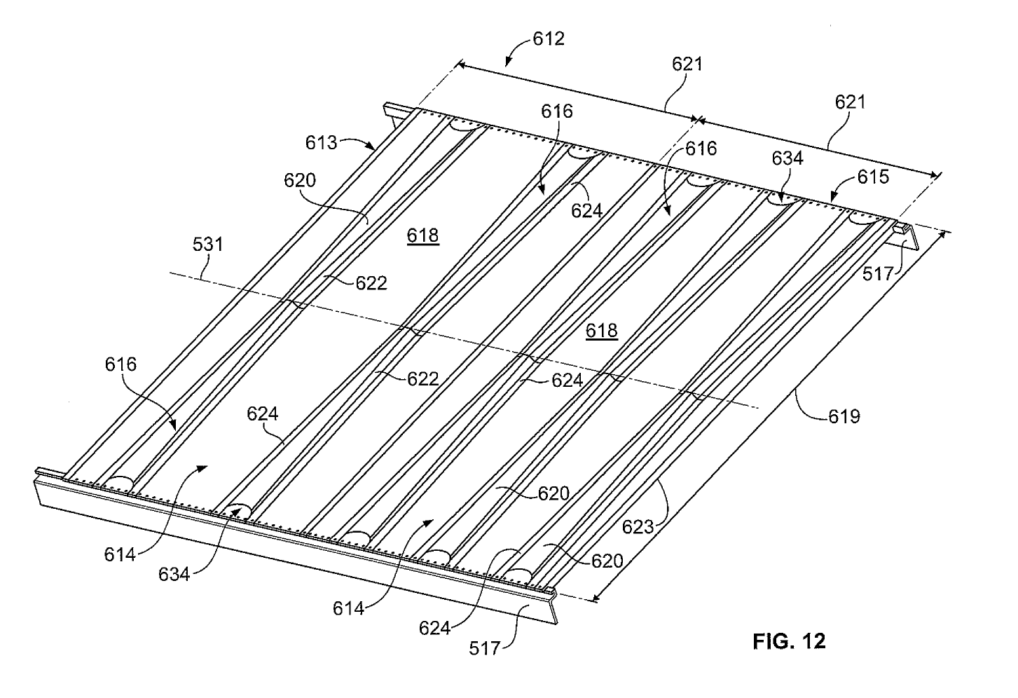

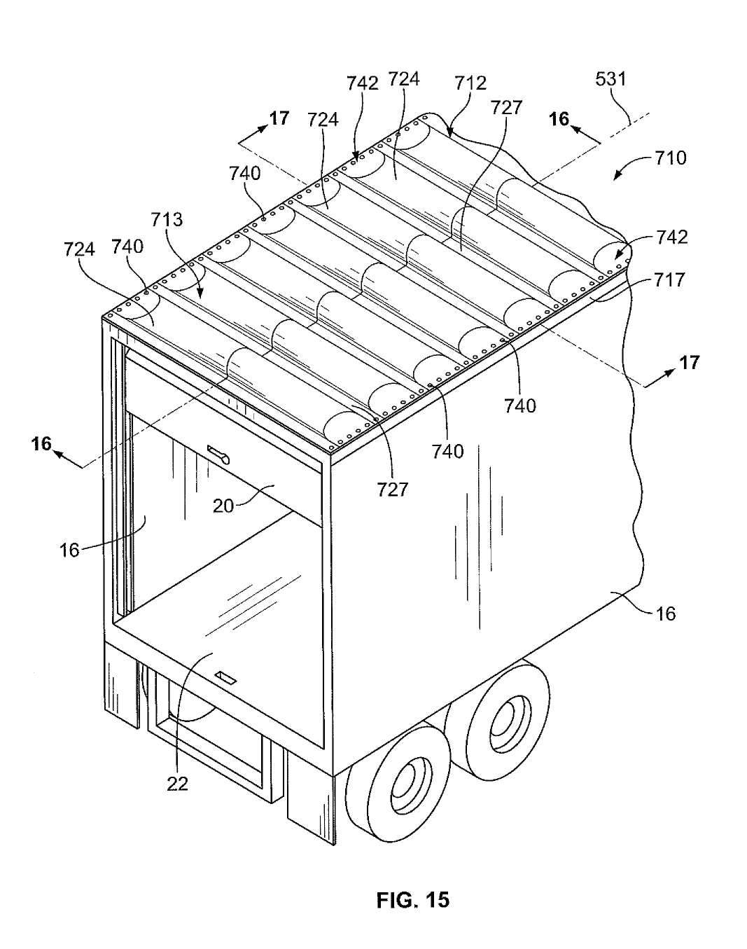

Similar to the roof bows 516, a centerline height 630 of each roof bow 616 taken at or near the longitudinal centerline 531 of the roof assembly 612 is approximately 1 inch. The height of each roof bow 616 decreases from the centerline height 630 to a second, peripheral height 632 taken at or near the side, or peripheral, ends of the roof assembly 612, as shown in FIG. 14. In particular, the peripheral height 632 may be approximately 0.24 inch. As shown in FIG. 14, the height of each roof bow 616 gradually decreases when moving outwardly from the centerline height 630 of approximately 1 inch to the peripheral height 613 of approximately 0.24 inch. In other words, the height of each roof bow 616 changes along the longitudinal axis of each roof bow 516. As shown in FIGS. 12 and 13, as the height of each roof bow 616 gradually decreases, the height of the side walls 622 similarly decreases.

While the overall height of the roof bows 616 decreases from the longitudinal centerline 531 of the roof assembly 612 to the peripheral end of the roof assembly, an overall width of each of the roof bows 616 increases from the longitudinal centerline 531 to each peripheral end. In particular, the width of each roof bow 616 increases from a first, centerline width 628 to a second, peripheral width 627 taken at or near the side, or peripheral, ends of the roof bow 616. In particular, the centerline width 628 may be approximately 3.0 inches while the peripheral width 627 may be approximately 5.0 inches. Thus, as shown in FIG. 13, the width of each roof bow 616 gradually increases when moving outwardly from the centerline width 628 of approximately 3.0 inches to the peripheral width 627 of approximately 5.0 inches. As shown in FIGS. 12 and 13, as the width of each roof bow 616 gradually increases, the width of the top wall 620 similarly increases. Finally, illustratively, a thickness (not shown) of each roof bow is approximately 0.019 inch. It should be understood, however, that a roof bow having other suitable dimensions may be used as well.

Similar to the roof bows 216, 516 shown in FIGS. 5 and 9-11, the roof bows 616 of the roof assembly 612 are spaced-apart from each other such that the flanges 624 of two adjacent roof bows 616 are not engaged with each other. As noted above, the roof bows 616 may be spaced any suitable distance apart from each other and the distance between any two adjacent roof bows 616 need not be the same. In other words, the spacing between the roof bows 616 may be regular and/or irregular. Further, it is within the scope of this disclosure for the flanges 624 of two adjacent roof bows 616 to engage each other as well.

Similar to the panels 513, 515, the panels 613, 615 each include a transverse cavity, or channel, 634 between the top and side walls 620, 622 of each roof bow 616 and the upper surface 618 of the sheet 614. Each cavity 634 is configured to extend transversely across the width of the trailer 10 to define a longitudinal axis perpendicular to a length of the of the roof assembly. Illustratively, a cross-sectional shape of each cavity generally defines a trapezoid due to the trapezoidal cross-sectional shape of the bows 616 themselves. It should be understood, however, that the roof bows 616, and thus the cavities 634 formed by the roof bows 616, may define any other suitable cross-sectional shape as well.

Illustratively, the cavities 634 of each panel 613, 615 may remain empty. Alternatively, the cavities 634 may be filled with a lightweight foam (not shown). This foam may operate to in conjunction with, or as an alternative to, other means by which the sheet 614 and the roof bows 616 are coupled to one another. In particular, the foam may be configured to bond with both the roof bows 616 and the sheet 614. Furthermore, the foam operates to provide increased structural rigidity of the roof assembly 612 while minimizing the overall weight of the roof assembly 612. It should be understood, however, that while the cavity 634 formed by each roof bow 616 may be filled with a foam material, these cavities 634 may be filled with other suitable materials as well.

In use, the panels 613, 615 of the roof assembly 612 are oriented such that a lower, or interior, surface (not shown) of the sheets 614 faces downwardly into the interior (not shown) of the trailer 10. In particular, the lower, or interior, surface 623 of the sheets 614 forms a smooth, inner roof surface of the interior storage space (not shown) of the trailer. Accordingly, such a smooth, inner roof surface does not include any downwardly extending support structures which may intrude upon the overall height of the storage space. Further, such a smooth, inner roof surface provides a surface free from protrusions that may be inadvertently hit by cargo during loading and/or unloading of cargo to and from the storage space, thus potentially damaging the cargo.

As noted above in regards to previously-described panels, any number of panels 613, 615 may be used to create a single roof assembly for a trailer, such as the trailer 10. Alternatively, a single elongated panel may be used as well. Further alternatively, one or more panels 613, 615 may be used in conjunction with one or more other roof panels to create a customized roof assembly for the trailer 10. In particular, one or more panels 613, 615 may be selectively placed along the length of the trailer 10 to satisfy certain performance needs or desires, for example.

Looking now to FIGS. 15-17, a truck trailer 710 includes a roof assembly 712 coupled to the opposite sidewalls 16 and the end wall assembly 18 of the trailer 710. Illustratively, the roof assembly 712 is made from one or more panels 713 including corrugations 724 extending across the width of the trailer 710 such that the longitudinal axis of each corrugation 724 is transverse to the longitudinal axis of the trailer 710. The corrugations 724 extend laterally across the width of the trailer 710 in order to provide strength to the roof assembly 712.

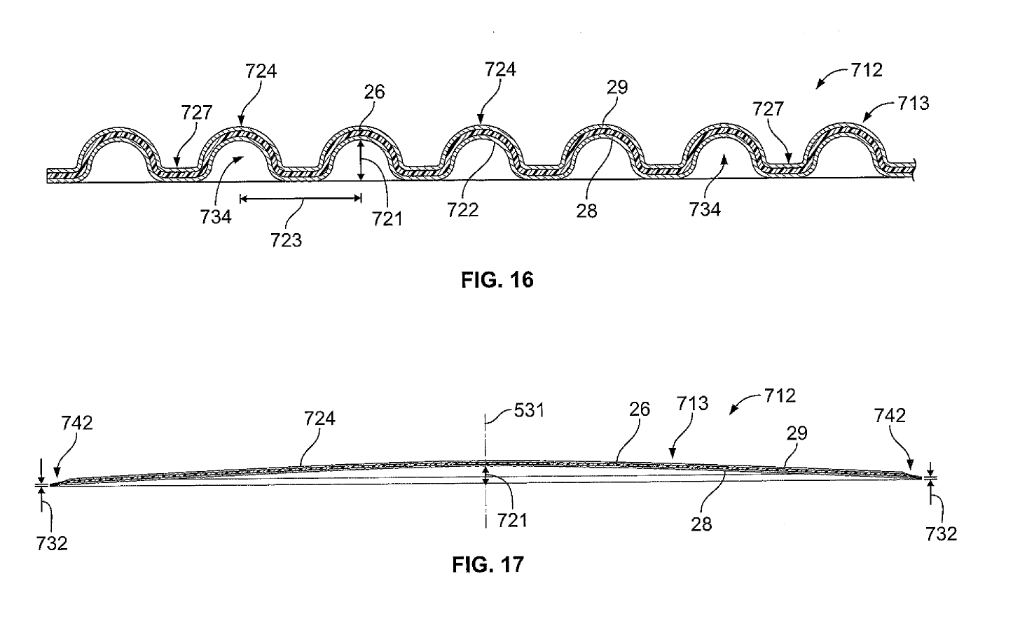

Illustratively, the panel 713 is corrugated to include curved walls. As shown in FIG. 16, a cross-section of each curved corrugation 724 taken along the centerline 531 of the roof assembly 712 is generally semi-circular in shape. It is within the scope of this disclosure, however, for the panel 713 to include corrugations having any other suitable cross-sectional curved or angular shape. Illustratively, the radius of each curved section 724 is approximately 1.0 inch such that a height 721 of each curved section 724 of the panel 713 is approximately 1.0 inch. Further illustratively, similar to the upper sheet 316 shown in FIGS. 6 and 7, a distance 723 between the center of adjacent curved sections 724 is approximately 1.5 inches. Of course, it should be understood that the panel 713 may include any suitable dimensions of and between the corrugated sections 724.

Illustratively, the corrugations 724 of the panel 713 define cavities 734 extending transversely across the width of the trailer 710. The cavities 734 of each panel 713 may remain empty. Alternatively, the cavities 734 may be filled with a lightweight foam (not shown) or other suitable material. In addition to the curved walls, or corrugations, 724, the panel 713 further includes a generally planar member or base wall 727 between each curved corrugation 724.

Similar to the panel 13 shown in FIGS. 1-3, the illustrative panel 713 of the roof assembly 712 is made from a composite material. The illustrative composite material of the panel 713 includes a plastic core 26 and inner and outer metal skins 28, 29 coupled to the plastic core 26, as shown in FIG. 16. As noted above, such a composite material provides a rigid, but lightweight and durable material. Illustratively, for example, the panels 713 of the roof assembly 712 may be made of a DURAPLATE® composite panel provided by Wabash National Corporation of Lafayette, Ind. While the illustrative panel or panels 713 of the roof assembly 712 are each made of the particular composite material described above, it should be understood that other suitable composite materials may be used as well. Further illustratively, it is within the scope of this disclosure for the panel 713 to be made from any number of suitable, non-composite materials such as metals, metal alloys, and/or plastics, for example.

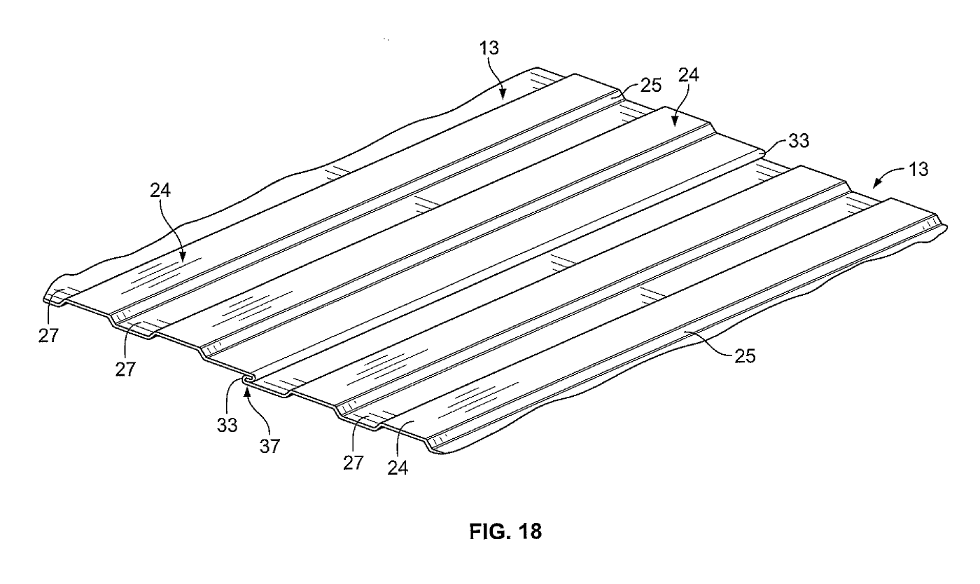

As noted above, a centerline height of each roof bow 724 taken at or near the longitudinal centerline 531 of the roof assembly 712 is approximately 1 inch. The longitudinal centerline 531 of the roof assembly 712 is parallel to the longitudinal centerline of the trailer 710. In other words, the longitudinal centerline 531 runs along a length of the trailer 710 from a front end of the trailer 710 to a rear end of the trailer 710 and is generally perpendicular to a longitudinal axis (not shown) of each of the corrugations 724. Similar to that described above in regards to the roof assemblies 512 and 612 shown in FIGS. 9-14, the height of each corrugation 724 decreases from the centerline height 721 to a second, peripheral height 732 taken at or near the side, or peripheral, ends 742 of the roof assembly 712, as shown in FIG. 17. The peripheral height 732 may be approximately 0.24 inch. Therefore, the height of each corrugation 724 gradually decreases when moving outwardly from the centerline height 721 of approximately 1 inch to the peripheral height 532 of approximately 0.24 inch. In other words, the height of each corrugation 724 changes along the longitudinal axis of each corrugation 724. Thus, as shown in FIGS. 15 and 17, the corrugations 724 are configured to progressively flatten outwardly from the longitudinal centerline 531 of the roof assembly 712 towards the upper edges of the top rail 717 thereby providing a generally continuous, generally planar end portion 742 of the roof assembly 712 to be coupled in a conventional manner to the top surface of the top rail 717.

The roof assembly 712 including the corrugations 724 may be coupled to the sidewalls 16 of the trailer 710 in a number of ways. For example, the outer ends 742 of each panel 713 having the reduced height 732 may be fixed to an upper edge of each respective sidewall 16 of the trailer 710. Illustratively, the sidewalls 16 each include a top rail 717 which extends along a length of the trailer 710. The top rail 717 includes an upper, generally horizontal planar surface (not shown) which also extends along a length of the trailer 710. Thus, the roof assembly 712 may be coupled to the top surface of the top rail 717 of each sidewall 16. More specifically, each peripheral end 742 of the roof assembly 712 is coupled to the top rail 717 of each sidewall 16 of the trailer 710. As shown, for example, the outer end portions 742 of the panel 713 are coupled to the top rail 717 using rivets 740. However, it should be understood that other suitable fasteners and/or adhesives may be used to couple the roof assembly 712 to the sidewalls 16 of the trailer 710.

In use as part of the roof assembly 712 of the trailer 710, the panel 713 is oriented such that the lower, or interior surface 722, of the panel 713 faces downwardly into the interior (not shown) of the trailer 710. Accordingly, the inner roof surface 722 does not include any downwardly extending support structures which may intrude upon the overall height of the storage space of the trailer 710. Further, the inner roof surface 722 provides a surface free from protrusions that may be inadvertently hit by cargo during loading and/or unloading of cargo to and from the storage space, thus potentially damaging the roof and/or the cargo. As noted above in regards to the panels 13, 113, 213, 313, 413, 513, and 613, any number of panels 713 may be used to create a single roof assembly for the trailer 710. As noted above, the panels 713 may be selectively placed along the length of the trailer 710 to satisfy certain performance needs or desired.

As noted above in regards to previously-described panels, any number of panels 713 may be used to create a single roof assembly 712 for the trailer 710. Alternatively, a single elongated panel may be used as well. Further alternatively, one or more panels 713 may be used in conjunction with one or more other roof panels to create a customized roof assembly for the trailer 710. In particular, one or more panels 713 may be selectively placed along the length of the trailer 710 to satisfy certain performance needs or desires, for example.

Illustratively, the panels 13, 113, 213, 313, 413, 513, 515, 613, 615, 713 disclosed herein define exterior support structures including the roof bows and corrugations described above. As such, both roof bows and corrugations of the roof assemblies described herein which are exposed to the surrounding environment operate as exterior support structures of the roof assembly. It should be understood that the roof bows and corrugations may be any suitable shape and size and may include a cross-section defining any suitable curved and/or angular shape. Further illustratively, the exterior support structures of the present disclosure are configured to extend laterally across a width of a trailer in order to provide stiffness to the roof assembly of the trailer while not extending downwardly into a storage space of the trailer. Accordingly, the panels 13, 113, 213, 313, 413, 513, 515, 613, 615, and 713 provide reinforced roof assemblies for storage containers, such as trailers, for example, which operate to reduce the protrusions into the storage space thus maximizing the storage space within the trailer and reducing the chance that cargo may inadvertently by damaged by hitting any such protrusions during loading and/or unloading of cargo to and from the storage space.

Illustratively, a roof assembly of the present disclosure may include one or more of each of the panels 13, 113, 213, 313, 413, 513, 515, 613, 615, and 713 in order to provide desired static and dynamic performance characteristics along a length of the trailer. Alternatively, the roof assembly may include a single panel which extends the entire length of the trailer. Further, while each panel 13, 113, 213, 313, 413, 513, 515, 613, 615, and 713 is generally planar, these panels may also be arched, or bowed, in the transverse plane, to assist, for example, with the shedding of water and/or snow on the roof assembly. In other words, the panels may be bowed upwardly across a width of the roof assembly. Further illustratively, it should be understood that the interior surface of the panels disclosed herein is generally devoid of structures depending downwardly therefrom. In other words, the interior surface of each of the roof assemblies disclosed herein, i.e., the surface which faces toward and is exposed to the interior cargo or storage space of the trailer, is generally devoid of support structures which depend downwardly into the storage space of the trailer.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. A roof assembly for a storage container, such as a truck trailer, comprising:
a sheet having a plurality of laterally-extending corrugations formed therein, wherein each corrugation is configured to progressively flatten outwardly from a longitudinal centerline of the roof assembly that is perpendicular to each corrugation towards an outer end of the sheet that is configured to be coupled to a sidewall of the truck trailer.

2. The roof assembly of claim 1, wherein each outer end of the sheet provides a continuous, generally planar surface of the roof assembly configured to be coupled to the sidewall of the truck trailer.

3. The roof assembly of claim 1, wherein a cross-section of each corrugation taken at the centerline of the roof assembly is generally semi-circular in shape.

4. The roof assembly of claim 1, wherein a height of each corrugation taken at the centerline of the roof assembly is approximately 1.0 inch.

5. The roof assembly of claim 4, wherein a height of the outer end of the sheet is approximately 0.24 inch.

6. The roof assembly of claim 1, wherein a distance between the center of two adjacent corrugations taken at the centerline of the roof assembly is approximately 1.5 inches.

7. The roof assembly of claim 1, wherein the sheet is made from a composite material.

8. The roof assembly of claim 7, wherein the composite material includes a foam core, an outer skin coupled to the foam core, and an inner skin coupled to the foam core.

9. The roof assembly of claim 1, wherein the sheet is bowed upwardly across a width of the roof assembly.

10. The roof assembly of claim 1, further including a second sheet having a plurality of laterally-extending corrugations formed therein, wherein each corrugation is configured to progressively flatten outwardly from a longitudinal centerline of the roof assembly that is perpendicular to each corrugation towards an outer end of the sheet that is configured to be coupled to the sidewall of the truck trailer.

11. The roof assembly of claim 1, wherein the interior surface of the sheet is generally devoid of support structures depending downwardly therefrom.

12. A roof assembly for a storage container, such as a truck trailer, comprising:
a plurality of exterior support structures configured to be coupled to a sidewall of the truck trailer, wherein each exterior support structure is configured to extend across a width of the truck trailer, and further wherein a height of each exterior support structure defines a first height at a longitudinal centerline of the roof assembly that is different than a second height at a peripheral end of the roof assembly.

13. The roof assembly of claim 12, further comprising a lower sheet having a generally planar interior surface configured to face toward an interior storage space of the truck trailer, wherein the plurality of exterior support structures are coupled to an exterior surface of the lower sheet.

14. The roof assembly of claim 13, wherein the plurality of exterior support structures include a plurality of roof bows, wherein each roof bow includes (i) a top wall spaced-apart from and generally parallel to the exterior surface of the lower sheet, (ii) a pair of side walls coupled to the top wall and extending between the top wall and the exterior surface of the lower sheet, and (iii) a flange coupled to each side wall and to the exterior surface of the lower sheet.

15. The roof assembly of claim 12, wherein the plurality of exterior support structures are corrugations formed in a sheet, and wherein the sheet further includes a planar section between adjacent corrugations.

16. The roof assembly of claim 15, wherein a cross-section of each corrugation taken at a longitudinal centerline of the roof assembly is generally semi-circular in shape.

17. The roof assembly of claim 15, wherein the sheet is made from a composite material and includes a plastic core, an inner metal skin coupled to an inner surface of the plastic core, and an outer metal skin coupled to an outer surface of the plastic core, wherein substantially an entire outer surface of the outer metal skin is configured to be exposed to the surrounding environment, and wherein substantially an entire inner surface of the inner metal skin is configured to be exposed to an interior storage space of the truck trailer.

18. The roof assembly of claim 12, wherein the first height is greater than the second height.

19. A storage container such as a trailer, for example, comprising:
first and second sidewall assemblies spaced-apart from each other;
a front end wall assembly coupled to each of the first and second sidewall assemblies;
a rear end wall assembly coupled to each of the first and second sidewall assemblies; and
a roof assembly coupled to the first and second sidewall assemblies, the front end wall assembly, and the rear end wall assembly in order to define a storage space therein, the roof assembly including a composite panel having a plurality of corrugations formed therein,
wherein each corrugation of the plurality of corrugations extends across a width of the storage container from the first sidewall to the second sidewall,
wherein the composite panel includes a plastic core, an inner metal skin coupled to an inner surface of the plastic core, and an outer metal skin coupled to an outer surface of the plastic core,
wherein substantially an entire outer surface of the outer metal skin is exposed to the surrounding environment, and
wherein substantially an entire inner surface of the inner metal skin is exposed to the storage space.

20. The storage container of claim 19, wherein each corrugation defines a first height at a longitudinal centerline of the roof assembly that is greater than a second height at a peripheral end of the roof assembly.
